(19) United States
(12) Patent Application Publication
(10) Pub. No.: US 2016/0168393 A1
(43) Pub. Date: Jun. 16, 2016

(54) Intumescent Coating

(71) Applicant: United States Mineral Products Company, Stanhope, NJ (US)

(72) Inventor: Robert Paul Kreh, Middle River, MD (US)

(73) Assignee: UNITED STATES MINERAL PRODUCTS COMPANY, Stanhope, NJ (US)

(21) Appl. No.: 14/568,248

(22) Filed: Dec. 12, 2014

(51) Int. Cl. C09D 5/18; B05D 1/38; C09D 163/00

(52) U.S. Cl. CPC C09D 5/185; C09D 163/00; B05D 1/38

(57) ABSTRACT

The present disclosure relates to intumescent fireproofing coatings and methods to apply these coatings. In particular, the disclosure relates to epoxy-based intumescent fireproofing coatings and methods of applying these coatings having at least one intermediate non-epoxy intumescent layer.

### FIELD OF THE TECHNOLOGY

The present disclosure relates to intumescent fireproofing coatings and methods to apply these coatings. In particular, the disclosure relates to epoxy-based intumescent fireproofing coatings and methods of applying these coatings having one or more intermediate non-epoxy intumescent layers. The one or more intermediate non-epoxy intumescent layers improve the thermal performance of the overall intumescent coating.

### BACKGROUND

Fireproofing is used in a variety of construction settings to provide fire retardation and/or thermal protection in the event of a fire. A variety of combustible or heat sensitive substrates are protected by fireproofing. Examples are wood, foam insulation, structural steel, walls and floors.

One type of fireproofing is an intumescent coating, wherein, during a fire, the coating swells and forms a fire-stable insulating foam “char.” The intumescent coating can be based on a variety of different resin types, such as polyvinylacetate, polyacrylate, polyurethanes and epoxy resins. Epoxy-based intumescent coatings are often employed to provide superior stability to environmental challenges, such as rain, salt water, temperature extremes and physical abuse. In addition, epoxy-based intumescent coatings form strong chars during a fire, providing resistance to very high temperatures, flame erosion and char sagging. For example, these coatings can provide fireproof protection for fires with fast, extreme temperature rises and strong, eroding flames (e.g., the UL 1709 standard and “jet fire”). These types of fires have been known to occur at petrochemical plants, gas storage facilities and off-shore oil facilities. These coatings can also provide fireproof protection for milder fires fueled by cellulosics or plastics. Standard evaluation of fireproofing can be done using the ASTM E119 standard.

While epoxy-based intumescent coatings can form strong, durable chars, these chars can be brittle, leading to cracks and fissures within the char. If these defects widen and extend down to the substrate, the insulation can be compromised, resulting in a fast temperature rise of the substrate. This is especially problematic on round substrates and at “outer” edges of substrates. For example, intumescent coatings are prone to failure at the corners of rectangular substrates and on the tips of wide-flange columns or beams.

To address this problem, a common solution is the placement of high-temperature-resistant mesh within the epoxy coating, e.g. between two coats of epoxy-intumescent layers. The mesh can be made from different materials include metal wire mesh, glass fiber mesh, sintered/pyrolyzed carbon fiber mesh and refractory mineral fiber mesh (e.g., basalt). Examples of meshes include Zoltek PX30FS08X4-COAT (Panex 30: Scrim Fabric 8×4 Coated) mesh, HK-1 from International Paint and IR-107 from Intumescent Associates Group. The mesh is generally placed at a depth of ⅓-⅔ of the total thickness of the coating. During a fire, as char-splitting moves downward through the fireproofing toward the substrate, it can be halted by the mesh, preventing the lower char from splitting. Thus, a degree of insulation can be maintained at these char splits where the mesh is present.

As noted above, the mesh is usually placed in the middle of the fireproofing (e.g., at a ⅓-⅔ depth) to prevent direct exposure of the mesh to the heat. It is also placed in the middle to allow the upper, outer fireproofing to experience char growth unrestricted by the mesh. The char expansion underneath the mesh is generally less than that above the mesh.

U.S. Pat. No. 5,433,991, incorporated herein by reference in its entirety, describes traditional embedding of mesh installation in an epoxy fireproofing layer. By embedding the mesh, the mesh is adhered to and encapsulated into an epoxy-intumescent material. This avoids the introduction of “foreign” material, or a different resin and/or fireproofing material, in contact with the mesh and between epoxy intumescent layers, which could result in deleterious effects, such as delamination or slippage between layers either before or during a fire. Also, the introduction of two different chemistries within the fireproofing, or in contact with the mesh, can have adverse effects on curing and/or the chemical/physical reactions necessary for intumescence.

A typical procedure for applying an intumescent fireproofing coating having a mesh is known. After application of a lower layer of uncured epoxy material, a period of time is allowed to pass, during which the lower layer “gels.” The mesh is applied while the viscosity is high enough such that the mesh can be pushed into the lower layer of epoxy material without excessive deformation of this layer or mesh. At the same time, the viscosity is low enough such that the mesh will penetrate the partially-cured layer. Ensuring the proper timing of this step is burdensome to the applicator and varies with the materials used and the environmental conditions (e.g., temperature). Sufficient embedment and leveling of the surface is also needed. This is generally accomplished by rolling the mesh/epoxy surface with a solvent-soaked “painting” roller. Solvent is used to prevent the sticking of the partially-cured epoxy to the surface of the roller. A highly volatile (and flammable) solvent, such as acetone, is used so that it will evaporate prior to application of the next epoxy layer (usually several hours later). This surface rolling presents an additional burden on the applicator. The release of solvent vapors is also undesirable due to potentially adverse effects to worker health and to the environment.

The present disclosure provides advantageous intumescent fireproofing coating compositions, kits and methods of applying the same. The disclosed coating compositions provide improved application procedures and are safe, environmentally friendly, less cumbersome to apply, and can perform as well as, or better, than known coatings.

### SUMMARY

In one embodiment, the present disclosure relates to an intumescent composition having a first epoxy resin layer having a top side and a bottom side, and including a first intumescent material, at least one non-epoxy resin layer in contact with the top or bottom side of the first epoxy resin layer, and including a second intumescent material. In one embodiment, a second epoxy resin layer is in contact with the at least one non-epoxy resin layer, the top or bottom side of the first epoxy resin layer or both, and including a third intumescent material. In some embodiments, all of the layers or all of the intumescent materials, or both swell as a result of heat exposure. The multi-layer composition can form a final coating, or the multi-layer composition can be repeated to produce a final coating. The intumescent composition can advantageously be applied as a fireproofing coating to a substrate. It is understood that the layers referred to above can be comprised of sub-layers, each being identical or different.

In another embodiment, the present disclosure relates to a method of coating a substrate with a first epoxy resin layer including a first intumescent material to a substrate, and also applying at least one non-epoxy resin layer including a second intumescent material in addition to the epoxy resin layer; and optionally applying a second epoxy resin layer including a third intumescent material to the non-epoxy resin layer, the first epoxy resin layer, or both, to form an intumescent composition, wherein the layers or the intumescent materials swell as a result of heat exposure. The multi-layer composition can form a final coating, or the multi-layer composition can be repeated to produce a final coating.

Additional features, functions and benefits associated with the present disclosure will be apparent from the detailed description which follows.

### DETAILED DESCRIPTION

An improved coating is provided by the epoxy-based intumescent coatings of the present disclosure. The coating includes one or more layers of non-epoxy intumescing material within layers of epoxy intumescent material. For example, one or more layers of intermediate non-epoxy intumescent material can be interspersed between layers of epoxy intumescent.

It is one object of the present disclosure to provide a straightforward and safe method for edge protection within an intumescent coating. Significant edge protection can be accomplished through the use of one or more non-epoxy intumescent layers. The non-epoxy intumescent layer(s) can improve the overall thermal insulation. For example, a non-epoxy intumescent material can be placed between two epoxy-based intumescent coatings. The non-epoxy intumescent layer or material can be useful to fill the voids within an intumescent char after one or more of the intumescent layers has cracked or split. Using a non-epoxy intumescent layer can reduce or eliminate the need for a mesh incorporated into the previously applied epoxy-intumescent layer. Additionally, minimal, if any, organic solvent is used or deleterious effects found.

As used herein the term “intumescent composition” refers to a composition that contains an intumescent material.

As used herein the term “layer” means a thickness of resin and intumescent material having a homogeneous composition that is separately formed from other layers. Each of the layers of the multilayer composition of the present disclosure may have the same or different widths and thicknesses. The resin and intumescent material of the different layers may be identical or different. In one embodiment, the non-epoxy resin layers of a composition having more than one non-epoxy resin layer are identical. In another embodiment, the non-epoxy resin layers of a composition having more than one non-epoxy resin layer have different resins, intumescent material or both.

As used herein the term “intumescent material” means a material that expands, foams, or swells when exposed to a sufficient amount of thermal energy.

In one embodiment, the present disclosure relates to an intumescent composition having a first epoxy resin layer with a top side and a bottom side, and including a first intumescent material, at least one non-epoxy resin layer in contact with the top side of the first epoxy resin layer, and including a second intumescent material, and optionally additional epoxy resin layers in contact with the at least one non-epoxy resin layer, the top side of the first resin layer or both, and including a third intumescent material, wherein all layers or intumescent materials swell as a result of heat exposure.

In one embodiment, one or more of the three layers can independently be comprised of multiple sub-layers of the same materials. The sub-layers may be applied at different times, by different means, and may vary in the degree of hardness, or other properties as described herein, between the sub-layers.

The epoxy resin layers can be applied to a substrate in need of fire retardation and/or thermal protection in the event of a fire. The thicknesses of the resin layers may vary depending on the substrate, the resin, the intumescent material and the degree of protection desired. In one embodiment, the epoxy resin layers can each have a dry film thickness between about 0.5 mm and about 20 mm. More particularly, each first resin layer can have a dry film thickness between about 1 mm and about 10 mm, or about 2 mm and about 6 mm. In some embodiments, the dry film thickness can be about 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm and 20 mm. These values can also be used to define a range of thicknesses, e.g., about 1 mm to about 15 mm, or about 2 mm to about 10 mm.

The thickness of each resin/intumescent layer can be consistent throughout the composition. For example, the variation in thickness of a resin/intumescent layer over a substrate or a substrate section can vary less than about 5% or about 10%. In some embodiments, each resin layer can also have an inconsistent thickness. Similarly, a resin layer can be continuous over a substrate or a substrate section. In some embodiments, one or more layers can be non-continuous. For example, a resin/intumescent layer on a flat surface can be continuous, have a consistent thickness, or both. In another example, a resin/intumescent layer on an uneven surface can be non-continuous, have a variable thickness, or both.

The epoxy resins can be selected from types known to those skilled in the art. In a preferred embodiment, the epoxy resin is two part, with some curing taking place after it is applied to a substrate. One part has epoxy functionality, while the other part reacts with said epoxy. This second part is often referred to as a hardener. In one embodiment, the hardener is comprised of one or more chemicals with amine functionality. In another embodiment, the epoxy contains one or more chemicals for viscosity reduction.

For example, suitable epoxy resins include aliphatic, aromatic, cyclic, acyclic, alicyclic and/or heterocyclic epoxy resins. For instance, epoxy resins may be glycidyl ethers derived from such polyhydric alcohols as ethylene glycol, diethylene glycol, triethylene glycol, 1,2-propylene glycol, 1,4-butylene glycol, 1,5-pentanediol, 1,2,6-hexanetriol; glycerol, trimethylolpropane, and Bisphenol-F (a condensation product of phenol and formaldehyde). The epoxy resin of the present disclosure can include mixtures of different epoxy resins. In one embodiment, the epoxy resin can be (2,2-bis[4-(2,3,-epoxy propoxy) phenyl]propane, commonly called the diglycidyl ether of bisphenol A (hereinafter DGEBA).

Hardeners, or epoxy curing agents, react with the epoxy resin to cross-link the resin and form a hard, durable material. Typically, any curing agents used to harden epoxy resins can be used. Suitable hardeners include diethylene triamine, 3,3-amino bis propylamine, triethylene tetraamine, tetraethylene pentamine,m-xylenediamine, amino/amides, di-carboxylic acid, tri-carboxylic acid, oxalic acid, phthalic acid, terephthalic acid, succinic acid, substituted succinic acids, tartaric acid, polymerized fatty acids, pyromellitic anhydride, trimellitic anhydride, phthalic anhydride, succinic anhydride, maleic anhydride. The ratio of hardener to epoxy can be between 1:5 and 5:1.

The epoxy resin layers, e.g., the first and the second resin layers, can also have the same resin. For example, the first and second epoxy resin layers can be epoxy resins. In one embodiment, the first and second resin layers can also contain different resins.

The amount of epoxy resin plus intumescent material in the epoxy resin layers of the composition can vary depending on the substrate, the resin, the intumescent material and the degree of protection desired. In one embodiment, the amount of epoxy resin plus intumescent material in the composition can be between about 10 wt % and about 90 wt %. More particularly, the amount of epoxy resin plus intumescent material in the composition can be between about 30 wt % and 70 wt %. In some embodiments, the amount of epoxy resin plus intumescent can be about 10, 15, 20, 25, 30, 35, 40, 45, 50, 55, 60, 65, 70, 75, 80, 85 or 90 wt %. These values can also be used to define a range of amounts, e.g., about 25 wt % to about 65 wt %.

Likewise, the amount of non-epoxy resin plus intumescent material in the non-epoxy resin layers of the composition can vary depending on the substrate, the resin, the intumescent material and the degree of protection desired. In one embodiment, the amount of non-epoxy resin plus intumescent material in the composition can be between about 10 wt % and about 90 wt %. More particularly, the amount of non-epoxy resin plus intumescent material in the composition can be between about 20 wt % and 80 wt %. In some embodiments, the amount of non-epoxy resin plus intumescent material can be about 10, 15, 20, 25, 30, 35, 40, 45, 50, 55, 60, 65, 70, 75, 80, 85 or 90 wt %. These values can also be used to define a range of amounts, e.g., about 25 wt % to about 65 wt %. It is understood that the layers referred to above can be comprised of sub-layers, each being identical or different.

Each resin layer can independently contain an intumescent material. The intumescent material imparts on the resultant intumescent resin layer, and the composition, with the ability to swell when exposed to heat. The intumescent materials can be independently selected from intumescent materials known in the art, and in particular, the group consisting of ammonium polyphosphate, melamine pyrophosphate, boric acid, limestone, titania, mineral solids, ceramic solids, glass solids, fibers, phosphate esters, borates, silica, melamine, tris(hydroxyethyl) isocyanurate (THEIC), clays, polyhydroxy organic chemicals, carbon, expanded graphite, benzyl alcohol, alumina, phenols, polysulfides and tris(dimethylaminomethyl)phenol. Additional suitable examples of char forming agents include polyisocyanurate, an ester of isocyanuric acid, an isocyanurate and hydroxyalkyl isocyanurates, such as tris(hydroxymethyl) isocyanurate, tris(3-hydroxy-n-propyl) isocyanurate, triglycidyl isocyanurate, and tris(2-hydroxyethyl)isocyanurate. Other char-forming agents can also be used, such as melamine, zinc borate, or antimony oxide.

The amount of intumescent material in the resin layers can vary depending on the substrate, the resin, the intumescent material and the degree of protection desired. In one embodiment, the amount of intumescent material independently in either the first or second resin layer can be between about 20 wt % and 80 wt %. More particularly, the amount of intumescent material independently in either the first or second resin layer can be between about 30 wt % and 70 wt %. In some embodiments, the amount of the intumescent material independently in either layer can be about 5, 10, 15, 20, 25, 30, 35, 40, 45, 50, 55, 60, 65, 70, 75 and 80 wt %. These values can also be used to define a range of amounts, e.g., about 5 wt % to about 50 wt %.

Suitable resin-intumescent materials (i.e., a resin containing an intumescent material) are known in the art. For example, epoxy-intumescent materials are known in the art, such as CHARTEK™ VII, Pyroclad Xl, Pittchar, Nanochar and Firetex M90. These suitable resin-intumescent materials typically consist of a two-part system. For instance, a two part epoxy system is described. A first part being an epoxy resin (binder) plus additives. A second part being a hardener plus additives. The two parts are mixed and used to coat the substrate. In some embodiments, the first resin layer containing a first intumescent material, the second resin layer containing a second intumescent material, or both are selected from these suitable resin-intumescent materials. Additional examples of suitable resin-intumescent materials are described in U.S. Pat. No. 6,069,812 and U.S. Pat. No. 5,070,119, each incorporated herein by reference in its entirety.

The resin layers can be applied by known techniques. In particular, the resin layers can be applied by roller, spray, trowel, brush and by similar means. In some instances, the suitable resin-intumescent material is applied and hardens after application. The hardening time can vary. Typical hardening times are between about 1 hr and 24 hr. For high-viscosity compositions, fast curing resin layers (e.g., between about 1 hr and 6 hr) or when applying a thick resin layer (e.g., between about 3 mm and 7 mm), the application can employ heated, plural systems wherein the parts are mixed in-line prior to being applied.

In some applications, a solvent can also be added to one or both of the parts of the epoxy resin system being mixed, and/or to the non-epoxy resin system. Said solvent can be water and/or organic-based. The mixed product/solvent composition can then be applied by brush, roller, trowel or spray applied, such as through a conventional “single-leg” paint sprayer or other spray-methods known to those skilled in the art of “paint spraying”. A preferred method is airless spray. Preferred solvents are water or organic chemicals which can contain aliphatic, aromatic, ketone, ether, and/or hydroxyl functionality.

Incorporated into and between the resin layers is at least one non-epoxy resin layer including an intumescent material. For example, the non-epoxy resin layer can be between a first and a second epoxy resin layer. In one embodiment, one or more epoxy resin layers can be underneath the innermost non-epoxy layer. The non-epoxy layers can be designed to swell and fill gaps or voids that occur in the char, such as when char splitting occurs. This can be due to a thermoplastic nature of the non-epoxy resin and/or the greater expansion of the non-epoxy intumescent layers.

The non-epoxy resin layer can contain a water-based, solvent-based or 100% solids resin known to one skilled in the art for use as an intumescent layer and having the properties described herein, such as those known to be used for protection in fires from cellulosic or plastic fuels. The resins used for the non-epoxy layers can independently be chosen from resins that are used in intumescent compositions, known to one skilled in the art. In particular, the resins used for the non-epoxy layers can be selected from the group consisting of polyvinyl acetate, a polyacrylate, a polyurethane, a polymethyl methacrylate, polyethylene/vinyl acetate, polystyrene, polyvinyl veova and copolymers and mixtures thereof. The amount of non-epoxy resin is generally between 5 and 25% of the total non-epoxy resin/intumescent formulation. The amount of non-epoxy resin can be about 3, 5, 7, 9, 11, 13, 15, 17, 19, 21, 23, 25, 27, 29, 31, 33, 35, 37 or 40% of the total non-epoxy resin/intumescent formulation. These values can also be used to define a range, such at between 7 and 23%.

Said non-epoxy resin/intumescent formulation can also contain chlorinated chemicals, examples being chlorinated hydrocarbons and chlorinated phosphorous-containing chemicals. The concentration of chlorinated chemicals is generally between 1 and 10%. The concentration can be about 1, 2, 3, 4, 5, 6, 7, 8, 9 or 10%. These values can also be used to define a range, such at between 2 and 8%.

The intermediate intumescent layer material can be selected, for example, from Sprayfilm® WB5 from Isolatek, AD Firefilm and Thermosorb from Carboline, and Albiclad TF and Albi 800 from Stanchem. The non-epoxy intumescent resin can be soluble in an organic solvent. For example, the liquid carrier for a non-epoxy intumescent layer can be an organic solvent, including, but not limited to, ketones, esters, alcohols, aromatics and hydrocarbons. The non-epoxy intumescent resin can be soluble or disperse-able in water. For example, the liquid carrier for a non-epoxy intumescent layer can be water.

The amount of the one or more non-epoxy intumescent layer(s) in the composition can vary depending on the substrate, the resin, the intumescent material and the degree of protection desired. In one embodiment, the amount of the one or more intermediate intumescent layer(s) in the composition can be between about 10 wt % and about 90 wt %. More particularly, the amount of the one or more intermediate intumescent layer(s) in the composition can be between about 20 wt % and 80 wt %. In some embodiments, the amount of the one or more intermediate intumescent layer(s) can be about 10, 15, 20, 25, 30, 35, 40, 45, 50, 55, 60, 65, 70, 75, 80, 85 or 90 wt %. These values can also be used to define a range of amounts, e.g., about 20 wt % to about 70 wt %.

The intumescent material in the non-epoxy layer can be independently selected from any of the intumescent materials described in the present disclosure for the resin layers, e.g., ammonium polyphosphate, melamine pyrophosphate, boric acid, limestone, titania, mineral solids, ceramic solids, glass solids, fibers, phosphate esters, borates, silica, melamine, tris(hydroxyethyl) isocyanurate, clays, polyhydroxy organic chemicals, carbon, expanded graphite, benzyl alcohol, alumina, phenols, polysulfides or tris(dimethylaminomethyl)phenol. The amount of the intumescent material in the non-epoxy layer(s) can be independently selected from the amounts provided for the intumescent materials described in the present disclosure for the resin layers, e.g., between about 20 wt % and 80 wt %. In some embodiments, the intermediate intumescent layer, e.g., the non-epoxy intumescent, is a non-epoxy resin and does not contain an intumescent material.

The at least one non-epoxy resin layer can be applied by known techniques. In particular, the layer can be applied by roller, spray, trowel, brush and by similar means. The thickness of the layer can vary. In particular, the thickness of at least one intermediate intumescent layer, independently or aggregated, can be between about 0.1 and about 15 mm. In some embodiments, the dry film thickness of the non-epoxy resin layer can be about 0.1, 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm. These values can also be used to define a range of thicknesses, e.g., about 0.5 mm to about 10 mm, or about 1 to about 5 mm.

The thickness of the non-epoxy resin layer(s) can be consistent throughout the composition. For example, the variation of the thickness of the non-epoxy resin layer can vary less than about 5% or about 10%. In some embodiments, the non-epoxy resin layer can also have an inconsistent thickness. Similarly, the non-epoxy resin layer can be continuous. In some embodiments, the non-epoxy resin layer can also be non-continuous. For example, a non-epoxy resin layer on a flat surface can be continuous, have a consistent thickness, or both. In another example, the non-epoxy resin layer on an uneven surface can be non-continuous, have a variable thickness, or both.

The intumescent composition of the present disclosure, one or more epoxy resin layers, one or more non-epoxy resin layers, or combinations thereof can independently contain additional components, such as a carbon source, spumific, an endothermic, an acid producer, filler, a fluxing agent, fibers, inorganic powders, or others as described herein. See U.S. Pat. Nos. 6,096,812 and 8,519,024, both are herein incorporated by reference in their entireties. The inclusion of a carbon source assisted in forming an inorganic char helping to hold the expanded foam together. Sources of carbon can be resins and/or hydroxyl containing organic compound may be employed. The carbon source should be compatible with the other components employed, and further should be soluble or dispersible in the water or other diluent employed. For instance, a polyol may be employed, such as glycerol, pentaerythritol, dipentaerythritol, tripentaerythritol; a monosaccharide may be employed such as a triose, tetrose, pentose, hexose, heptose, octose, an aldose or a ketose; a disaccharide may be employed, or a trisaccharide or a polysaccharide, or a starch. A combination of polyols may be employed.

A spumific compound (“blowing agent”) decomposes upon thermal exposure to release an expansion gas (e.g., ammonia, melamine, nitrogen, carbon dioxide or water vapor), thereby expanding the char to increase char thickness. Typically, the spumific will off-gas at a temperature at which the cured epoxy resin is soft but which is below the temperature at which carbonaceous char is formed. Thus, char which is formed is expanded and thereby better insulates the substrate due to the low-density foam. In one embodiment, the composition contains a spumific which provides a degree of intumescence (ratio of the volume of intumesced coating to the volume of non-itumesced coating) below 8 when heated according to the UL 1709 test protocol.

Suitable spumifics include, for example, ammonium polyphosphate, THEIC, melamine, methylolated melamine, hexamethoxymethyl melamine, melamine monophosphate, melamine biphosphate, melamine polyphosphate, melamine pyrophosphate, urea, dimethylurea, dicyandiamide, guanylurea phosphate, glycine, and boric acid. The spumific can comprise 5-30% of the resin/intumescent layer or more preferably 10-25%. The spumific can also comprise about 3, 5, 7, 9, 11, 13, 15, 17, 19, 21, 23, 25, 27 or 30% of the resin/intumescent layer. These values can also be used to define a range, such as 7-21%.

Compositions of the present disclosure can include endothermic additives including, for example, the above spumifics as well as water-containing inorganics. Some examples are gypsum and inorganic hydroxides. Examples are inorganic hydroxides such as aluminum and magnesium hydroxides. Concentrations of water-containing inorganics are generally between 0.5 and 10%, more typically between 2 and 5%. The endothermic additive can also comprise about 0.1, 0.3, 0.5, 0.7, 0.9, 1, 2, 3, 4, 5, 6, 7, 8, 9 or 10% of the composition. These values can also be used to define a range, such as between 1 and 7%.

Compositions of the present disclosure can also contain acid-producing chemicals. Examples are ethylenediamine, ammonium or melamine sulfates, phosphates, pyrophosphates and polyphosphates. At high temperatures, the bases, such as ethylenediamine, melamine or ammonia can volatilize, leaving behind acidic sulfuric or phosphoric acids. These acids are believed to react with carbon-rich additives to produce carbon-containing char. The total concentration acid-producing chemicals is generally between 5 and 30%, more typically between 10 and 25%. The acid-producing chemical can also comprise about 2, 4, 6, 8, 10, 12, 14, 16, 18, 20, 22, 24, 26, 28 or 30% of the composition. These values can also be used to define a range, such as between 6 and 26%.

Compositions of the present disclosure can also include at least one type of low density filler. Typically, the low density filler is used to further reduce the intumescent coating density while also insulating the coated substrate by reducing the thermal conductivity of the intumescent coating and of its resultant char. Suitable low density fillers include expanded glasses, such as expanded perlite, expanded vermiculite and hollow microspheres, for example, glass, ceramic and organic microspheres. The low density filler can be small in size to freely be sprayed. In one embodiment, the low density filler has a particle size of less than 0.04 inches. In another embodiment, the composition contains expanded perlite having a particle size of 97% through 30 mesh (particle size 0.023 inches) as a filler. The total concentration of low-density filler is generally between 1 and 10%. The low density filler can also comprise about 1, 2, 3, 4, 5, 6, 7, 8, 9 or 10% of the composition. These values can also be used to define a range, such as between 1 and 7%.

Compositions of the present disclosure can also include at least one type of refractory solid in the form of powder or plates. Typically, the refractory solid is used to moderate the degree of intumescence as well as to strengthen the char once it is formed. Suitable refractory powders include inorganic oxides, glass, silicas, titania, borates, zinc compounds, clays, wollastinite, talcs, and the like. Titania can also be considered to react with other intumescing ingredients, and is generally of concentrations between 0.5 and 15%, or more commonly between 2 and 11%. Total refractory solids other than Titania are generally in the concentration range of 0.5 to 11%. The refractory solids can also comprise about 0.1, 0.3, 0.5, 0.7, 0.9, 1, 2, 3, 4, 5, 6, 7, 8, 9, 10, 11 or 12% of the composition. These values can also be used to define a range, such as between 0.7 and 7%.

Compositions of the present disclosure can also include a fluxing agent that will form, or enhance the formation of, a glass matrix within the char during char formation. Upon heating under char-forming conditions, the fluxing agent reacts with at least a portion of a phosphorous-containing component and at least a portion of a silicon-containing component to form an at least partially softened, or liquid, phosphorosilicate glass which expands and foams within the char due to gases released by thermal decomposition of one or more components of the intumescent coating. Suitable fluxing agents include, for example, hydrated boric acid, zinc borate, boron oxide, sodium borate, potassium borate, ammonium borate or borate esters such as butylborates or phenylborates. Other suitable fluxing agents include metal oxides of titanium, molybdenum, calcium, iron, aluminum, zinc and tin. The total concentration of fluxing agents is generally between 5 and 50%, and more typically between 10 and 40%. The fluxing agent can also comprise about 3, 5, 10, 15, 20, 25, 30, 35, 40, 45 or 50% of the composition. These values can also be used to define a range, such as between 10 and 35%.

Compositions of the present disclosure can also include fibers. Fibers are added for many purposes, such as (1) to reduce sagging before and during hardening by increasing the thixotropic index, (2) to reinforce the cured intumescent coating and prevent cracking and shrinkage thereof, (3) to reinforce or strengthen the char formed from the intumescent coating, (4) to further enhance gas retention through physical obstruction and/or increased hydrogen-bonding, and/or (5) to form a phosphorosilicate glass within the char which improves the insulation of the coated substrate and durability of the char. The fibers can also improve hangability of the intumescent fireproofing composition. The total concentration of fibers of length greater than 0.1 mm is generally between 0.5 and 10%. The fibers can also comprise about 0.1, 0.3, 0.5, 0.7, 0.9, 1, 2, 3, 4, 5, 6, 7, 8, 9, 10, 11 or 12% of the composition. These values can also be used to define a range, such as between 0.9 and 9%.

The fibers can take the form of glass fibers, e.g., glass fibers having a length of at least about 0.2 mm in length. In further exemplary embodiments, the fibers are at least about 0.5 mm in length; and in still further exemplary embodiments the fibers are on the order of 2 mm to 6 mm in length. Other types of fibers may be employed according to the present disclosure, e.g., ceramic fibers such as mineral wool, alumina, alumina-magnesia-silica, aluminosilicate, silica, zirconia, quartz fibers and the like. The overall formulation exhibits superior thermal performance while simultaneously achieving enhanced hangability performance.

Typically, fibers having a high surface area are dispersed within the composition, layers or combinations thereof, to increase the thixotropic index such that a coating, sprayed on a vertical surface or overhead (ceiling) surface, will experience no significant movement prior to hardening . Suitable high surface area fibers also include, for example, ceramic, aramid, glass and other fibrillated fibers. The weight ratio of high surface area fiber-to-epoxy resin is usually between about 1:40 to about 1:20, and is preferably between about 1:35 to about 1:20.

Fibers used to form phosphorosilicate glass within the char can be silicon-containing fibers. This fiber is an amorphous mineral fiber that contains silicon dioxide such as mineral wool fiber. The weight ratio of glass-forming fiber-to-epoxy resin is usually between about 1:30 to about 1:15, and is preferably between about 1:25 to 1:20.

Fibers used in the method and composition of this disclosure can be sufficiently short and small in diameter to pass through the spray nozzle without significant clogging. Further, the use of smaller diameter fibers results in more fiber interlocking mastic per unit mass of fiber contained therein.

In one embodiment, the non-epoxy intumescent layer contains high-temperature-stable fibers of length 0.5-6 mm. These fibers are comprised of materials that retain some tensile strength at temperatures above 500° F. Representative materials are glass, high-temperature-stable carbon, aramids and refractory inorganics. In one embodiment, the epoxy intumescent contains an acid source, blowing agent, high-temperature-stable powder and high-temperature-stable fibers of length 0.5-6 mm. In another embodiment, the epoxy intumescent contains an acid source, spumific, boron-containing additive, high-temperature-stable powder and high-temperature-stable fibers of length 0.5-6 mm.

Suitable boron compounds, for example, hydrated boric acid, zinc borate, boron oxide, sodium borate, potassium borate, ammonium borate or borate esters such as butylborates or phenylborates. The total concentration of boron compounds is generally between 5 and 50%, and more typically between 10 and 40%. The total concentration in the boron compounds can be 5, 7, 9, 11, 13, 15, 17, 19, 21, 23, 25, 27, 29, 31, 33, 35, 37, 39 or 40%. These values can also be used to define a range, such as between 11 and 35%.

The epoxy resin/intumescent formulation can also contain chlorinated chemicals, examples being chlorinated hydrocarbons and chlorinated phosphorous-containing chemicals. The concentration of chlorinated chemicals is generally between 1 and 10%. The intumescent composition of the present disclosure can be used to protect a variety of substrates. In one embodiment, the intumescent composition of the present disclosure can be used to protect a substrate having edges or sides wherein the edges or sides are more difficult to protect using non-mesh containing intumescent compositions and, therefore, are more susceptible to damage from high temperature environments. The type of material to be protected can include metal, wooden and foamed polymeric materials in need of a thermal barrier against the effects of overheating. The metals can include aluminum, iron, and steel. The substrate to be protected can be in the form of an I-beam (e.g., steel I-beam), a flange, a wide-flange, a round column or a rectangular column. The intermediate intumescent material can be applied to the entire surface of a substrate, or only onto those surfaces most prone to cracking of the char (e.g., flange tips and/or other areas containing outer corners).

The epoxy resin/intumescent and non-epoxy/intumescent layers, or combinations thereof can swell as a result of heat exposure. The degree of swelling can vary depending on the substrate, level of heat exposure and/or the amount and/or composition of the layers.

The intumescent composition of the present disclosure can extend the time it takes for a substrate to reach its critical failure temperature. For example, the intumescent composition of the present disclosure can extend the time it takes for steel to reach its critical failure temperature (e.g., 550 degrees C.) under standard test conditions. In one embodiment, the intumescent composition of the present disclosure can extend the time it takes for a substrate to reach is critical failure temperature by 10%, 20%, 30%, 40%, 50%, 60%, 80%, 100%, 150%, or 200%. These values can also be used to define a range of time extension, such as from about 20% to about 50%.

In some embodiments, a mesh can also be applied to the resin layer(s) or intermediate layer(s), or both, to reinforce the composition. The use of a mesh can provide reinforcing of the char once it starts to form. The mesh can reduce the chance that the coating will crack of fissure. Fissures reduce the protection provide by the coating because a fissure allows heat to more readily reach the substrate. The use of a mesh reduces the depth, length, or both of any fissures formed.

The mesh can be selected from meshes known to one skilled in the art that are used in intumescent compositions. The mesh can be selected from known high-temperature-stable meshes and can be made from fibers/strands of metal, glass, oxidized carbon or refractory inorganics. Examples are Zoltec, HK-1 and IR-107 from Intumescents Associates Group.

The mesh can be made using fibrous materials, such as carbon, boron and graphite fibers. Fibers containing carbides, such as silicon carbide or titanium carbide; borides, such as titanium diborides; oxides, such as alumina or silica; or ceramic can be used. The fibers can be used in the form of monofilaments, multifilaments, tows or yarns. In different embodiments, the mesh can be contain high temperature fibers, a welded wire mesh, or combinations thereof.

The amount and properties of the mesh such as density, size of fibers, flexibility, and ability to retain tensile strength at high temperatures are those known to those skilled in the art, represented by the Underwriters Laboratory 1709 designs for Carboline Type 440, Thermo-Lag 2000, Thermo-Lag 3000, Pitt-Char XP, Pitt-char XP2, Firetex M90, Firetex M93, Chartek 4, Chartek 7, and Chartek 1709.

The mesh can be located between the first and second resin layers. The mesh can be above, below, within, or combinations thereof, the intermediate intumescent layer. The mesh can be partially embedded into the first resin layer, the intermediate intumescent layer, or both. The mesh can be located at the surface of the resin layer, or intermediate layer, and partially located under the surface of the respective layer. In some embodiments, portions of the mesh can also be embedded into the resin or intermediate intumescent layer (i.e., located under the surface). The distance the mesh is embedded can vary. A single mesh piece can have sections that are non-embedded, partially embedded, embedded, or combinations thereof.

The present disclosure also relates to a method of applying an intumescent composition, as described herein, onto a substrate, the method including applying two or more resin/intumescent layers to a substrate containing at least one epoxy resin/intumescent layer and at least one non-epoxy resin/intumescent layer , to form an intumescent composition, wherein the intumescent materials swell as a result of heat exposure.

The different layers can be applied by known techniques. In particular, they can be independently applied by roller, spray, trowel, brush and by similar means.

In one embodiment, a single first epoxy resin layer, a single second non-epoxy resin layer and a single third epoxy/intumescent layer is applied. In other embodiments, multiple epoxy resin/intumescent layers can be applied to the substrate prior to the non-epoxy resin/intumescent layer, multiple intermediate layers may be applied to the first epoxy resin/intumescent layer(s), multiple resin layers can be applied to the intermediate layer(s), or combinations thereof. In one embodiment, one or more non-epoxy resin layers are applied prior to the first epoxy resin/intumescent layers(s).

After application of the intermediate layer, such as a non-epoxy intumescent material, a set amount of time is allotted for a degree of cure and/or drying to occur prior to application of subsequent resin layers, such as epoxy-intumescent layers. The duration of this cure/dry time can be chosen by those skilled in the art, based on the composition of the intermediate intumescent layer and material. Subsequent intumescent layers can be applied before the underlying layer(s) is substantially cured. Outer intumescent layers can also be applied after underlying resin/intumescent layer(s) is/are substantially cured.

In one embodiment, the intermediate intumescent layer is applied 30 minutes after the first resin layer is applied (or has sufficient viscosity to support such application), or after 1 hour, 90 minutes, 2 hours, 2.5 hours, 3 hours, 4 hours, 5 hours, 8 hours, 16 hours, 1 day, 2 days, 1 week, or longer. These times can also define a range of when the intermediate intumescent layers can be applied to the first resin layers, such as between 3 and 8 hours. For example, each non-epoxy intumescent layer is applied a minimum of 3 hours after the underlying and adjacent epoxy intumescent layer.

In another embodiment, the next resin layer is applied about 30 minutes, after the underlying layer is applied (or has sufficient viscosity to support such application), or after 1 hour, 90 minutes, 2 hours, 2.5 hours, 3 hours, 4 hours, 5 hours, 8 hours, 16 hours, 1 day, 2 days, 1 week, or longer. These times can also define a range of when the next resin layers can be applied to an underlying layer(s), such as between 3 and 8 hours. For example, after applying a layer of non-epoxy intumescent, the next layer of material is applied at a minimum of 3 hours later.

The composition (e.g., first resin layer, etc) can be applied to a substrate in need for thermal protection. The composition can be applied to the entire surface of the substrate, or just portions thereof. Each resin/intumescent layer can be contained within the entire composition covering the substrate, or it can be contained within just portions thereof. For example, non-epoxy-intumescent layers can be on the entire surface area of the substrate. Also, the non-epoxy-intumescent layers need not be on all of, or some of, the web areas of the substrate.

In some embodiments, a mesh can be applied with or in the composition. The mesh can be applied by known techniques. The mesh can also be applied as separate pieces over or between the various layers. The mesh can be applied as one continuous piece or separate pieces, covering all or parts of the surface area. For example, the separate pieces can be placed around each tip of an I-column or I-beam. The mesh can be applied to the layer(s) before or during the cure time, or can be embedded into the respective layer. The mesh can be embedded after the resin layer has cured enough to accept the mesh and hold the mesh in place after embedding. That is, the viscosity is low enough to allow the mesh to penetrate the un-cured or partially-cured layer, but high enough to allow the mesh to be pushed into the epoxy material without excessive deformation of either the layer or the mesh. Adhesive mesh can be used to secure the mesh. Examples of said adhesive are epoxy resins, rubbery solid or water-based emulsions.

Prior to the application of the intumescent composition of the present disclosure, the substrate can be primed with a primer (e.g., presenting a primed surface). The substrate can also be an un-primed substrate (e.g., the intumescent composition is applied directly onto the substrate.). Some advantages of a primer are corrosion inhibition and enhanced adhesion to the substrate. The primer is preferably non-aqueous, and more preferably an epoxy primer. Similarly, a substrate coated with an intumescent composition of the present disclosure may further be coated with a top coat on top of the intumescent composition. A top coat can provide additional durability to physical or environmental challenges. In particular topcoats can provide protection against water, temperature extremes and sunlight.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

In Examples 1-3, new wide flange W8×28 columns, 16 inches high, were used. The steel surfaces were pre-cleaned with acetone (e.g., wiping with acetone). The surfaces were allowed to dry, and then all surfaces of the columns were uniformly trowel-coated with a layer of a commercially available epoxy intumescent product. To each column, about 1900 grams were applied in the coating. The depth of the layer was approximately 4.5 mm. Next, either no mesh was used (Example 1), a mesh was used and embedded using known techniques (Example 2), or a non-epoxy intermediate intumescent layer was used (Example 3). To each column, a second coat of epoxy intumescent, identical to the first, was then applied in each example.

The mesh used in Example 2 was a Zoltek PX30FS08X4-COAT (Panex 30: Scrim Fabric 8×4 Coated) mesh.

After allowing the coatings to fully cure over 4 days at 120° F., the columns were cooled and tested in a high temperature furnace. The time/temperature profile of the test followed the UL 1709 standard, except that 2,000° F. was reached in 30 minutes, instead of the 5 minutes as specified in UL 1709.

### Example 1—Control

In this example (control), no mesh or intermediate non-epoxy layer was used between the first and second layers of epoxy intumescent. Twenty six minutes into the furnace test, the char had split apart at all four flange tips and steel substrate was seen. The test was halted at 60 minutes, at which time the char had also pulled away from the steel on the top half of the outer flanges. This demonstrated the poor performance in the absence of mesh or an intermediate non-epoxy layer.

### Example 2—Control

In this example (control), mesh was embedded on both flanges, the first layer of epoxy intumescent prior to applying the second layer of epoxy intumescent. A piece of mesh, 16″ high, was wrapped around each flange tip starting at the corner between the web and the inner flange and extending around the flange tip and 2.5″ on the outer flange. This left a 1.5″ strip without mesh down the middle of each outer flange. The first layer of epoxy was not fully cured at the time the mesh was applied. Penetration of the mesh into the partially-cured epoxy was accomplished with pressure supplied by an acetone-soaked “paint-type” roller. After additional curing of the epoxy, the second coat of epoxy intumescent was applied.

The furnace test was run for 60 minutes, during which time the outer layer of char split at the flange tips, but the lower layer was held together by the mesh. No steel was exposed, and the char remained on the column in all areas. This was a control run to demonstrate the expected (good) performance with the mesh embedded in the epoxy intumescent. No deleterious effects were found from employing the method of the present disclosure for mesh attachment relative to the conventional “embedment” technique.

### Example 3—Intermediate Intumescent Layer Composition and Method

The procedure of Example 2 was repeated, but the mesh was not embedded into the epoxy intumescent. The first layer of epoxy intumescent was allowed to cure for the normal amount of time prior to application of the second layer, but prior to application of this second layer, a layer of Sprayfilm® WB5 was applied (i.e., intermediate intumescent layer) to the first layer of epoxy intumescent. The thickness of the intermediate intumescent layer was about 1 mm. About 16 hours after application of the intermediate intumescent layer (to allow for drying, etc.) the second layer of epoxy intumescent was applied.

The furnace test was run for 60 minutes, during which time the outer layer of char split at the flange tips, but the char openings were filled with the intermediate intumescent layer. No steel was exposed, and the char remained on the column in all areas. This demonstrated that the performance with the intermediate intumescent layer performed the same as mesh embedded in the epoxy intumescent.

In Examples 4-5, new wide flange W10×49 columns, 48 inches high, were used. The steel surfaces were pre-treated with acetone (e.g., wiping with acetone). The surface was then primed with a two-part epoxy paint, e.g., Macropoxy 646 from Sherwin Williams, and allowed to dry. The surfaces were then uniformly trowel-coated with two coats (i.e., two layers) of a commercially-available epoxy intumescent product. To each column, about 8400 grams were applied in each coating. The depth of each coating was approximately 5.5 mm. Next, either no edge protection was used (Example 4) or an intermediate intumescent layer was used as described in the present disclosure (Example 5). A third coat of epoxy intumescent, identical to the first two, was then applied in each example.

After allowing the coatings to fully cure over 14 days at 70-100° F., the columns were cooled and tested in a high temperature furnace at Underwriters Laboratories in Northbrook, Ill. The time/temperature profile of the test followed the UL 1709 standard.

### Example 4—Control

In this example (control), no method of edge protection was applied prior to applying the third layer of epoxy intumescent. The furnace test was run for 83 minutes at which time the average temperature of the column reached 1000° F. Twenty minutes into the furnace test, steel began to be visible in some areas at flange tips. By the end of the test, steel substrate was seen at all flange tips and the char had also pulled away from the steel on the top half of the outer flange. This demonstrated the poor performance of the coating in the absence of any edge protection.

### Example 5—Intermediate Intumescent Layer Composition and Method

The procedure of Example 4 was repeated, but a layer of non-epoxy intumescent was incorporated. The first layers of epoxy intumescent were allowed to cure for the normal amount of time prior to application of the third layer (epoxy resin/intumescent), but prior to the application of this third layer, a layer of Sprayfilm® WB5 was applied (i.e., an intermediate, non-epoxy resin/ intumescent layer) over the first two layers of epoxy intumescent. The thickness of the intermediate intumescent layer was about 1 mm. Approximately 16 hours after application of the intermediate intumescent layer (to allow for drying, etc.) the third layer of epoxy intumescent, identical to the first two, was applied.

The furnace test was run for 117 minutes at which time the average temperature of the column reached 1000° F. During this time, the outer layer of char split at the flange tips, but all of the char openings, with the exception of one, were filled with non-epoxy resin/intumescent char. No steel was exposed in the epoxy char openings that were filled with the non-epoxy resin/intumescent char, and the char remained on the column in all areas. This demonstrated that the incorporation of a non-epoxy resin/intumescent layer, as described in the present disclosure, increased the thermal protection of the substrate. The increased time to 1000° F., the significant edge protection and lack of splitting demonstrated that the performance was significantly improved by the inclusion of the non-epoxy resin/intumescent layer.

While this disclosure has been particularly shown and described with reference to example embodiments thereof, it will be understood by those skilled in the art that various changes in form and details may be made therein without departing from the scope of the invention encompassed by the appended claims.

We claim:

1. An intumescent composition comprising:
(i) a first epoxy resin layer having a top side and a bottom side, and including a first intumescent material;
(ii) at least one non-epoxy resin layer in contact with the top side of the first resin layer, and including a second intumescent material;
(iii) a second epoxy resin layer in contact with the at least one non-epoxy resin layer, and including a third intumescent material;
wherein all layers swell as a result of heat exposure.

2. The intumescent composition of claim 1, wherein the at least one non-epoxy resin is independently selected from the group consisting of polyvinylacetate, polyacrylate, polyurethane, polyvinylalkoxylate, polystyrene, polymethylmethacrylate, polyethylene/vinyl acetate, polyvinyl veova, and homopolymers, copolymers or mixtures thereof.

4. The intumescent composition of claim 1, wherein the three intumescent materials are independently selected from the group consisting of ammonium polyphosphate, boric acid, limestone, titania, mineral solids, ceramic solids, glass solids, fibers, phosphate esters, borates, silica, melamine, tris(hydroxyethyl) isocyanurate, clays, polyhydroxy organic chemicals, carbon, expanded graphite, benzyl alcohol, alumina, phenols, polysulfides, tris(dimethylaminomethyl)phenol.

5. The intumescent composition of claim 1, wherein the non-epoxy resin is solvent-based.

6. The intumescent composition of claim 1, wherein the composition excludes a mesh.

7. The intumescent composition of claim 1, wherein the at least one non-epoxy layer comprises a spumific.

8. The intumescent composition of claim 1, wherein the at least one non-epoxy layer comprises a filler.

9. The intumescent composition of claim 1, wherein the at least one non-epoxy layer comprises a fiber.

10. The intumescent composition of claim 1, wherein the non-epoxy resin is water-based.

11. The intumescent composition of claim 1, wherein the at least one non-epoxy layer comprises a high-temperature-stable fiber, wherein the fiber has a length between about 0.5 and about 6.0 mm.

12. The intumescent composition of claim 1, wherein the at least one non-epoxy resin layer comprises a non-epoxy resin, a char forming agent, a spumific, a polyhydroxy hydrocarbon carbon source, and a filler.

13. The intumescent composition of claim 1, wherein the at least one non-epoxy resin layer comprises a resin, a char forming agent, a spumific, a polyhydroxy hydrocarbon carbon source, a filler, and a high-temperature-stable fiber.

14. The intumescent composition of claim 1, wherein the first and second epoxy resin layers independently have a thickness between about 1 and about 20 mm.

15. The intumescent composition of claim 1, wherein the at least one non-epoxy resin layer has a thickness between about 0.5 and about 10 mm.

16. An article comprising a substrate with edges or sides, wherein the substrate is coated with an intumescent composition of claim 1.

17. The article of claim 16, wherein the substrate includes steel.

18. The article of claim 16, wherein the substrate is an I-beam a wide-flange shaped object, a round column or a rectangular column.

19. A method comprising:
(i) applying a first epoxy resin layer including an intumescent material to a substrate;
(ii) applying at least one non-epoxy resin layer including a second intumescent material to the epoxy resin layer; and
(iii) applying a second epoxy resin layer including a third intumescent material to the at least one non-epoxy resin layer to form an intumescent composition;
wherein the intumescent materials swell as a result of heat exposure.

20. The method of claim 19, wherein the at least one non-epoxy resin layer is a single layer.

21. The method of claim 19, wherein the first epoxy resin layer is substantially cured prior to the application of the non-epoxy resin layer.

22. The method of claim 19, wherein the at least one non-epoxy resin layer is applied a minimum of three hours after the first epoxy resin layer.

23. The method of claim 19, wherein the second epoxy resin layer is applied a minimum of three hours after the at least one non-epoxy resin layer is applied.

24. The method of claim 19, wherein at least one of the epoxy resin layers is applied without the use of a plural system.
